(19) United States
(12) Patent Application Publication
(10) Pub. No.: US 2003/0161977 A1
(43) Pub. Date: Aug. 28, 2003

(54) Four layer nozzle for forming four layer articles

(76) Inventors: Douglas Sabin, Marblehead, MA (US); Paul Swenson, South Hamilton, MA (US)

Correspondence Address: DUANE MORRIS, LLP, One Liberty Place, Philadelphia, PA, 19103, US

(21) Appl. No.: 10/355,351

(22) Filed: Jan. 31, 2003

Related U.S. Application Data
(63) Continuation-in-part of application No. 09/828,254, filed on Apr. 6, 2001.
(60) Provisional application No. 60/353,408, filed on Feb. 1, 2002.

(51) Int. Cl. B32B 1/02; B29C 47/06

(52) U.S. Cl. 428/35.7; 264/171.27; 264/173.12; 425/130; 425/131.1

(57) ABSTRACT

A nozzle for extruding an article has at least three layers of thermoplastic materials. A housing has a longitudinal axis. At least three extrusion dies are contained in the housing and aligned with the longitudinal axis. Each die has a face with a die channel in the face. Each die channel is a closed geometric figure. Each die channel has at least one inlet for receiving a respective thermoplastic material. Each die channel provides a respective outlet for feeding a respective one of the plurality of layers of thermoplastic materials to a respective flow channel within the housing. The flow channels deliver the plurality of layers so that at least three of the layers combine within the nozzle at substantially the same coordinate measured along the longitudinal axis.

This application is a continuation-in-part of U.S. patent application Ser. No. 09/828,254, filed Apr. 6, 2001. This application claims the benefit of U.S. Provisional Patent Application No. 60/353,408, filed Feb. 1, 2002.

### FIELD OF THE INVENTION

The present invention relates to plastic injection molding technology generally, and more specifically to an extrusion nozzle for an injection molding system.

### BACKGROUND OF THE INVENTION

U.S. Pat. No. 6,187,241 B1 to Paul Swenson (hereinafter, “Swenson”) is incorporated by reference as though set forth in its entirety herein. Swenson describes a method and apparatus for co-extruding multiple plastic material flowing streams for injecting through a gate region into a mold cavity to produce a molded product. The plastic materials flow from stream sources along a longitudinally extending hollow extruder. The outer (cover) and interior (core) streams are received from the extruder. The streams of flowing plastic materials are combined, with at least one stream that is to serve as an interior core of a resulting molded plastic product within outer and inner streams of plastic material to serve as covering plastic material layers. The combined streams are restricted within and along the longitudinally extending tubular extruder to force the combined streams to flow along concentric annular flow paths within and along the longitudinally extending extruder to the cavity gate region. The annular interior core stream is encased by inner and outer annular covering plastic material stream layers. At the gate region, the concentric annular streams are split along opposite transverse directions to inject into corresponding opposite transverse sections of the cavity. The flow is adjusted so that the annular interior core layer flows along a path of substantially zero gradient of the flow velocity profile transversely of the extruder. This velocity profile enables the leading edge of the (interior) core layer to not become tapered as it flows from the area of combination to the cavity end of the mold gate.

Swenson describes an embodiment in which a moveable throttle or restrictor valve pin can vary the percentage of the inner layer of material in the inner annular flow layer vs. the outer annular flow layer of the combined flow stream downstream of the combining area. Thus, the thickness of the inner layer relative to the outer layer can be controlled. Changing the relative volumes of the inner and outer layers shifts the position of the core (interior) layer in the mold cavity to produce a part with controlled inner and outer layer thickness on both surfaces of the molded part. If the inner and outer layer flow is evenly distributed between the inner annular flow layer and outer annular flow layer, the inner or outer layer thickness will be similar on inside and outside of the molded part. If the flow to the inner and outer layers is biased toward either the inner or outer annular flow layers, the inner and outer layer thickness in the molded part will be similarly biased on the corresponding surface molded from the biased annular layers. This method allows creation of three annular layers at the gate. In some applications it may be desirable to introduce a fourth layer.

A method and apparatus providing the opportunity of an extra layer in a relatively small space is desired.

### SUMMARY OF THE INVENTION

One aspect of the invention is a die for extruding thermoplastic material, of a type having at least one inlet for receiving the thermoplastic material and at least one outlet for distributing the thermoplastic material. The die has a face, with a channel in the face. The channel provides the outlet for distributing the thermoplastic material. The channel is a closed geometric figure. The channel has at least two arcuate portions. The arcuate portions meet to form at least first and second vertices of said closed geometric figure. The first and second vertices have first and second inlets for receiving the thermoplastic material.

Another aspect of the invention is a nozzle for extruding an article having at least three layers of thermoplastic materials. A housing has a longitudinal axis. At least three extrusion dies are contained in the housing and aligned with the longitudinal axis. Each die has a face with a die channel in the face. Each die channel is a closed geometric figure. Each die channel has at least one inlet for receiving a respective thermoplastic material. Each die channel provides a respective outlet for feeding a respective one of the plurality of layers of thermoplastic materials to a respective flow channel within the housing. The flow channels deliver the plurality of layers so that at least three of the layers combine within the nozzle at substantially the same coordinate measured along the longitudinal axis.

### BRIEF DESCRIPTION OF THE DRAWINGS

FIG. 1 is an isometric view of an exemplary nozzle according to the present invention.

FIG. 2 is an exploded view of the nozzle of FIG. 1 from below, with the valve pin removed for ease of viewing.

FIG. 3 is an exploded view of the nozzle of FIG. 1 from above, with the valve pin removed for ease of viewing.

FIG. 4 is a top plan view of the nozzle of FIG. 1.

FIG. 5A is a cross section of the nozzle shown in FIG. 4, taken along section line 5A-5A of FIG. 4.

FIG. 5B is an elevation view of the nozzle of FIG. 5A, viewed from section line 5B-5B of FIG. 4, showing internal hidden features with dashed lines.

FIG. 5C is an enlarged detail of FIG. 5A.

FIG. 6 is a cross section of the nozzle shown in FIG. 4, taken along section line 6-6.

FIG. 7 is a cross section of the nozzle shown in FIG. 4, taken along section line 7-7.

FIG. 8 is a cross section of the nozzle shown in FIG. 4, taken along section line 8-8.

FIG. 9 is a cross section of the nozzle shown in FIG. 4, taken along section line 9-9.

FIG. 10 is a cross section of the nozzle shown in FIG. 4, taken along section line 10-10.

FIGS. 11A-11D are isometric views of the four extrusion dies shown in FIGS. 2 and 3, showing the double extrusion coat hanger die channels.

FIG. 11E is a plan view of the second extrusion die, shown in FIG. 11B.

FIG. 12A shows a timing diagram for injection of inner and outer layer (encapsulating shell) material, first core layer and second core layer.

FIGS. 12B through 12E show an article at different times during its formation, when the materials are injected as shown in FIG. 12A.

### DETAILED DESCRIPTION

U.S. patent application Ser. No. 09/828,254, filed Apr. 6, 2001 and U.S. Provisional Patent Application No. 60/353,408, filed Feb. 1, 2002 are both incorporated by reference herein in their entireties, as though set forth fully herein.

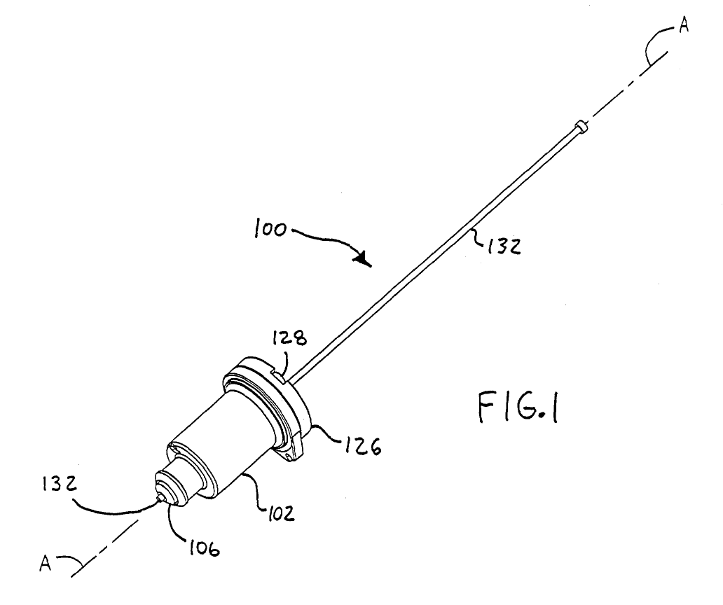

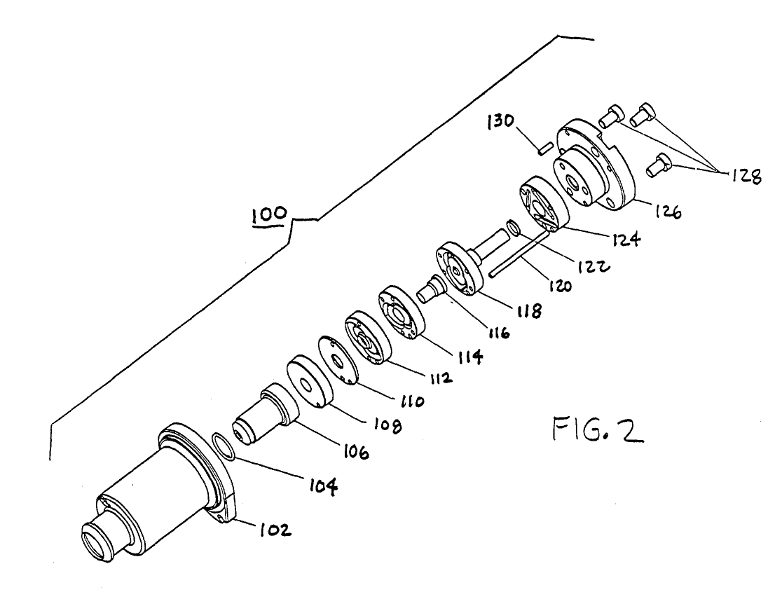

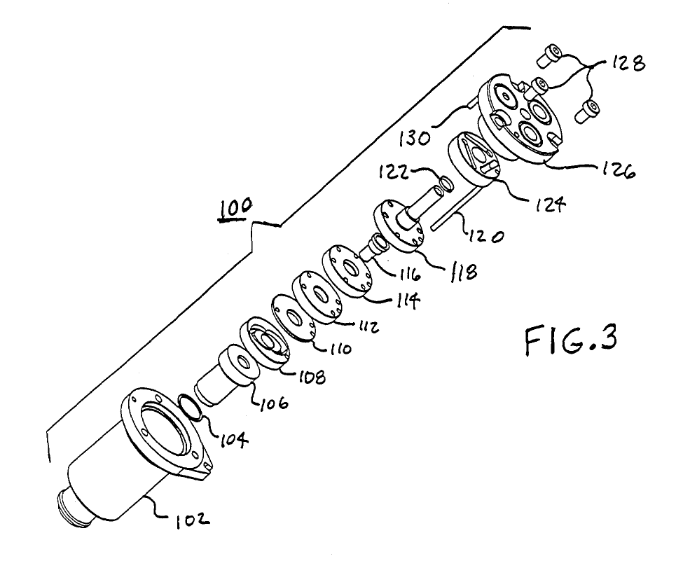

FIG. 1 shows an exemplary extruder nozzle 100 for extruding an article, such as a pre-form for an injection molded bottle having at least three, preferably four, layers of thermoplastic materials. FIG. 2 is an exploded view of the nozzle 100 of FIG. 1 from below, with the valve pin removed for ease of viewing. FIG. 3 is another exploded view of the nozzle of FIG. 2, as seen from above.

The nozzle 100 has a housing or body 102 having a central longitudinal axis A, which passes through the center of the valve throttle pin 132. A nozzle inlet portion 126 seals against the nozzle body 102 creating a pressure boundary that prevents leaks. The nozzle inlet portion 126 has three inlet channels 127a-127c for receiving three different thermoplastic materials.

As explained below, the three nozzle inlet channels 127a-127c receive three materials, which flow through the nozzle inlet 126 and are coupled to respective ones of the extrusion dies 118, 114, 112 and 108 by way of a distribution layer 124. The distribution layer 124 separates each inlet channel 127a-127c into a respective pair of feed channels that are equidistant from the inlet channel and oriented parallel to the longitudinal axis A. The equidistant feed channels of distribution layer 124 also have the same cross section and consequentially the same pressure drop from the inlets 127a-127c. The six feed channels emerging from the distribution layer 124 (two from each material inlet 127a-127c) form a hexagon shape with each channel located at a vertex.

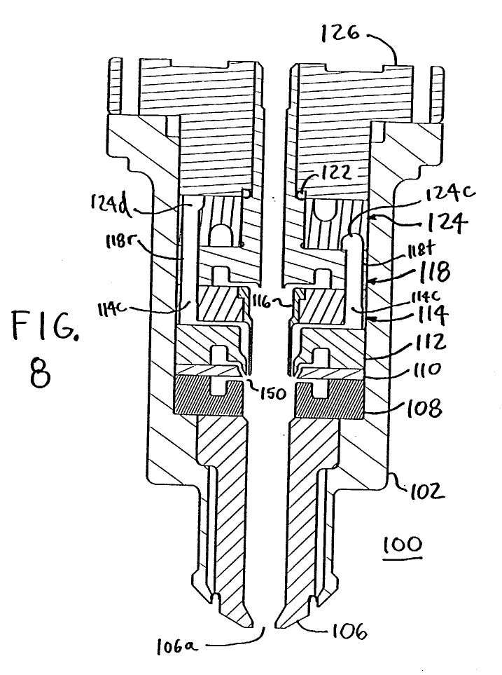

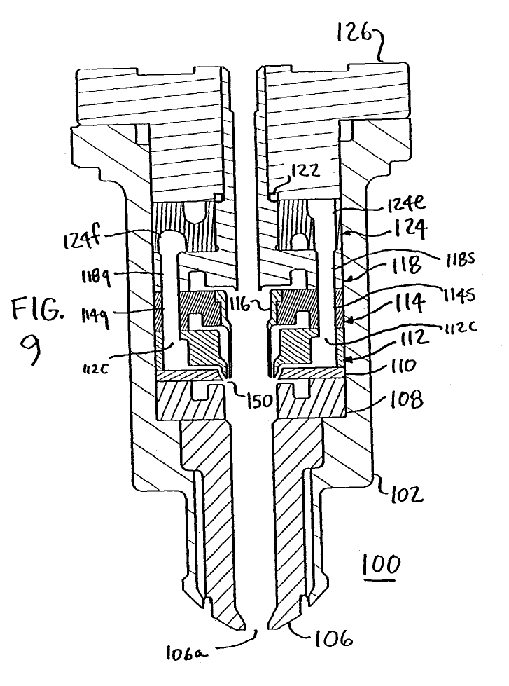

The six feed channels continue into and through the first extrusion die 118. FIGS. 8-10 show the connections between the distribution layer 124 and the various extrusion dies. In FIG. 10, distribution layer passages 124a and 124b feed the inlets 118c of the first extrusion die 118 and the inlets 108c of extrusion die 108 (by way of longitudinal passages 118u, 114u, and 112u on one side, and passages 118v, 114v and 112v on the opposite side. In FIG. 8, distribution layer passages 124c and 124d feed the inlets 114c of the second extrusion die (by way of aligned passages 118u on one side and 118v on the opposite side. In FIG. 9, distribution layer passages 124e and 124f feed the inlets 112c of the third extrusion die (by way of aligned passages 118q, 114q on one side, and passages 118s, 114s on the opposite side. The distribution layer 124 also has an alignment hole that receives an alignment pin 120, to align the distribution layer and the extrusion dies.

At least three extrusion dies are contained in the housing 102 and aligned with the longitudinal axis A. Preferably, the exemplary nozzle 100 has four extrusion dies 118, 114, 112, and 108, and outputs four annular flow layers of the thermoplastic materials.

Each die channel 118b, 114b, 112b and 108b is a closed geometric figure. Each die channel has at least one inlet for receiving a respective thermoplastic material. The exemplary dies have two inlets, 118c, 114c, 112c, 108c. Each die channel 118b, 114b, 112b and 108b provides a respective outlet for feeding a respective one of the plurality of layers of thermoplastic materials to a respective flow channel within the housing 102. As explained below, the inlets 118c, 114c, and 112c pass through the rear surface of each die, but the inlet 108c is a portion of the channel 108b near the vertices 108h and 108i; the material enters channel 108b through the front face 108a.

Each die 118, 114, 112, and 108 has a face (118a, 114a, 112a and 108a, respectively) with a die channel (118b, 114b, 112b and 108b, respectively) in the face, the die channel providing the outlet for distributing the thermoplastic material. Each extrusion die 118, 114, 112, and 108 has a pair of die inlets 118c, 114c, 112c, 108c for receiving a respective thermoplastic material from each one of the pair of feed channels corresponding to that extrusion die. Each of the exemplary extrusion dies has a channel in the form of a “double coat hanger” configuration. Coat hanger type die passages are known in the art, and are described, for example, in U.S. Pat. Nos. 4,017,240 and 5,728,407, which are incorporated by reference herein in their entireties.

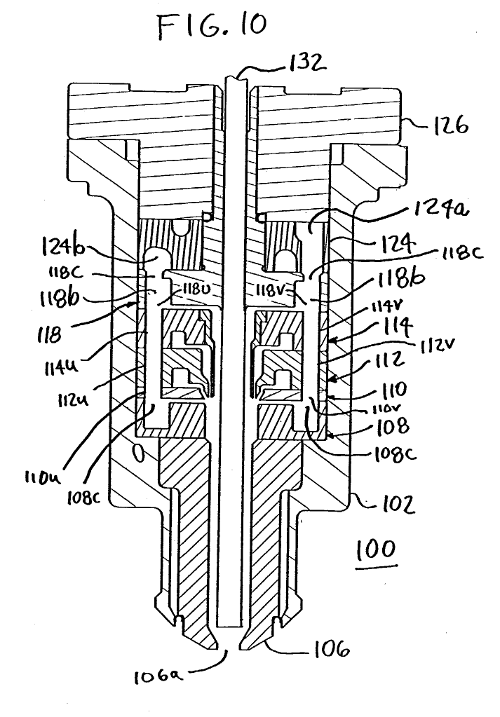

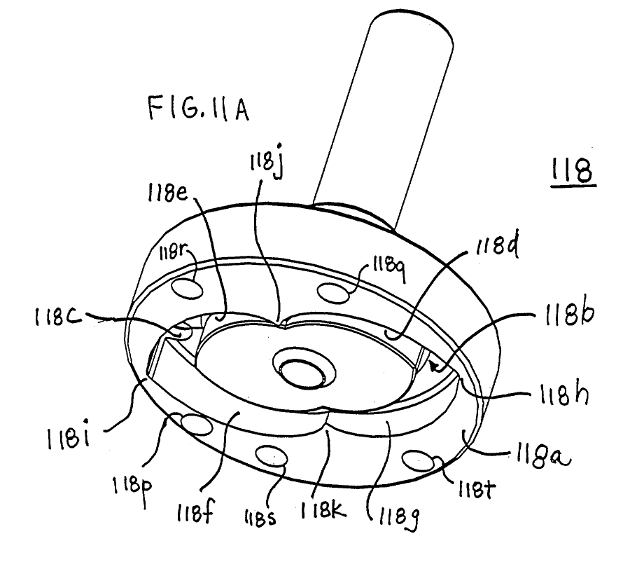

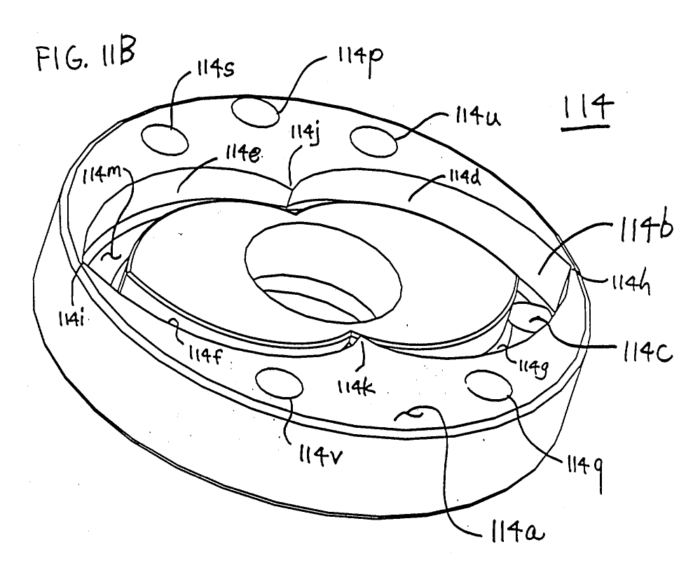

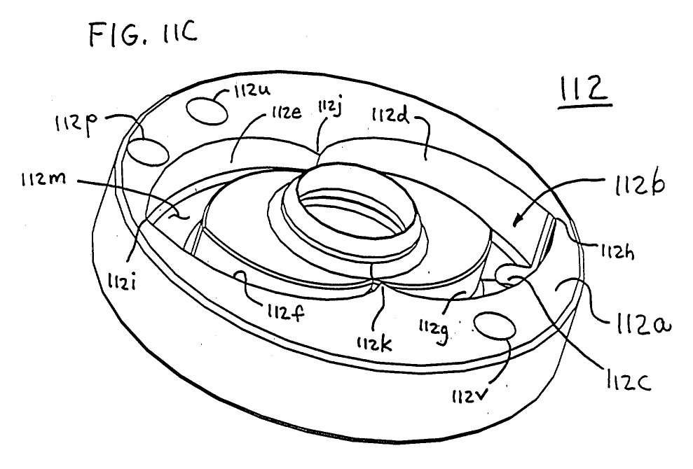

Each double coat hanger channel has at least two arcuate portions. In the exemplary dies 118, 114, 112, 108, the channel has a kiss shape (best seen in FIG. 11E), and the channel has at least a first arcuate portion (e.g., 118d), a second arcuate portion (e.g., 118e), a third arcuate portion (e.g., 118f) and a fourth arcuate portion (e.g., 118g). The first and fourth arcuate portions 118d and 118g meet at the first vertex 118h. The second and third arcuate portions 118e and 118f meet at the second vertex 118i. The first and second inlets 118c that receive the thermoplastic material are located in the first and second vertices 118h and 118i. The first and second vertices 118h, 118i point outwardly, away from a center of the die.

In the exemplary kiss-shaped double coat-hanger configuration, the first and second arcuate portions 118d and 118e meet at the third vertex 118j. The third and fourth arcuate portions 118f and 118g meet at the fourth vertex 118k. The third and fourth vertices 118j, 118k point inwardly, towards a center of the die (which coincides with the central axis A of the nozzle 102, shown in FIG. 1). Each of the exemplary channels 118b, 114b, 112b and 108b has a plane of symmetry S (shown in FIG. 11E) substantially midway between the first and second vertices, e.g., 118h and 118i. Thus, for example, in die channel 118b, the first arcuate section 118d and the fourth arcuate section 118g are mirror images of second arcuate section 118e and third arcuate section 118f, respectively. A preferred channel has a second plane of symmetry perpendicular to the plane of symmetry S, passing through the vertices (e.g., 118h, 118i) of the channel along the major axis of the kiss shape. Thus, for example, in die channel 118b, the first arcuate section 118d and the second arcuate section 118e are mirror images of fourth arcuate section 118g and third arcuate section 118f, respectively.

The coat hanger configuration allows formation of an extruded sheet by merging a substantially cylindrical runner into a flattened triangular passageway of gradually decreasing thickness. In each of the exemplary extrusion dies, a pair of runners on opposite sides of the die forms an annular extruded layer. The double coat hanger configuration is most easily seen in FIG. 11E, which shows the second layer extrusion die 114 in plan view. (The kiss-shaped channel is the same or substantially similar in extrusion dies 118, 112 and 108.) Channel sections 114d and 114g form a first coat hanger channel portion, and channel sections 114e and 114f form a second coat hanger channel portion. A respective inlet 114c provides the thermoplastic material to each respective coat hanger channel portion.

Each extrusion die channel 118b, 114b, 112b, 108b has a gap and groove geometry that is calculated to create substantially equal pressure drop for any streamline from a nozzle inlet corresponding to the respective thermoplastic material and any location on the annular layer of that one thermoplastic material at a given coordinate along the longitudinal axis. Thus, each extrusion die 118, 114, 112, 108 creates a respective annular layer of uniform thickness during operation of the nozzle 100.

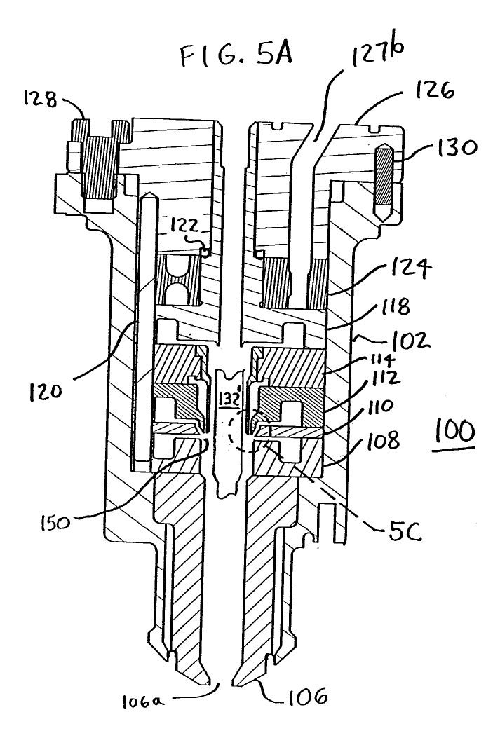

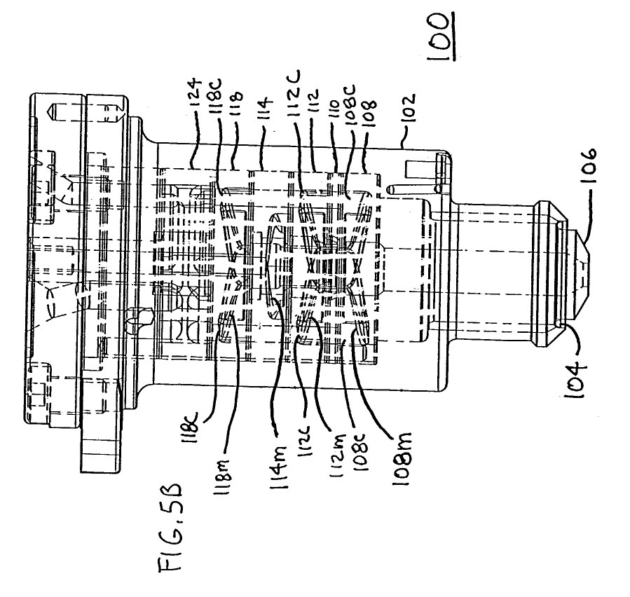

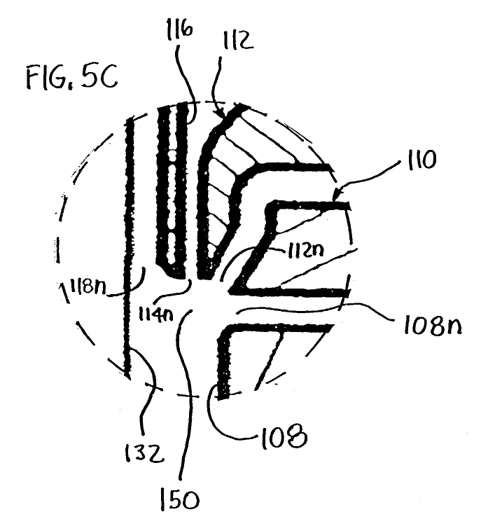

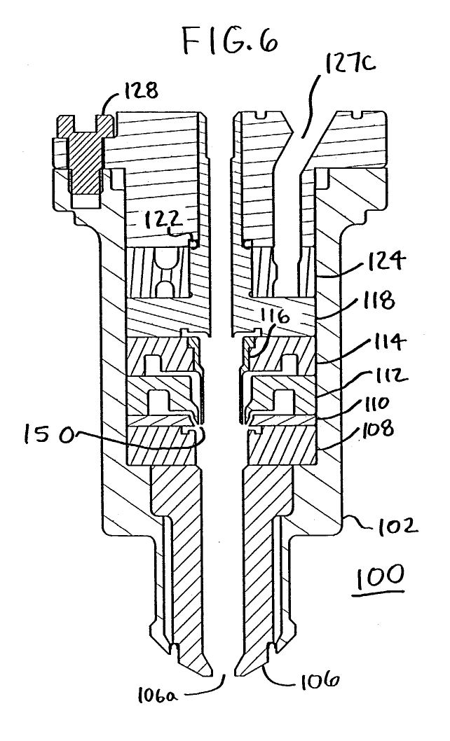

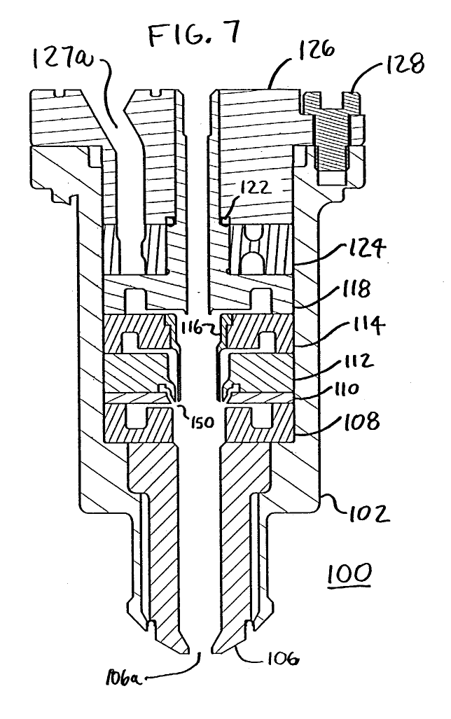

By feeding each extrusion die 118, 114, 112, 108 with two feed channels (inlets) instead of one, a smaller minimum radial dimension of the gap/groove geometry can be maintained than with a single inlet die. The shapes of the gap and groove are determined by material behavior at certain assumed flow rates and temperatures. The exemplary double radial coat hanger dies 118, 114, 112, 108 are “kiss” shaped with the inlets 118c, 114c, 112c, 108c at the corners 118h, 118i, 114h, 114i, 112h, 112i, 108h, 108i of the “mouth” and an annular exit in the middle (Best seen in FIGS. 5A and 6-10. As best seen in FIG. 2, the kiss-shaped channels of the extrusion dies 118, 114, and 112 are rotated 120 degrees from each other around the longitudinal axis A. This kiss shape leaves room near the perimeter of the die for independent through-passages that connect to passages in other dies above and/or below without interfering with the layer of material distributed by the kiss-shaped channel. Thus, the kiss shape, when repeated at 120 degree intervals also permits feed channels for other layers to be aligned axially and contained within the nozzle body 102. This solves a major problem with multi-layer design, in that certain material must always pass by the means of distributing other layers into annular layers. If prior art techniques are used, this would create large nozzle diameters. Large nozzle diameters are costly because they limit the number of parts that can be molded on a particular size platen—machine size. As apparent from the sectional views of FIGS. 5A and 6-10, the kiss shaped channels 118b and 108b of first and fourth extrusion dies 118 and 108 are aligned with each other.

The channels 118b, 114b, 112b, 108b each have a base surface 118m, 114m, 112m and 108m that is inclined relative to the face 118a, 114a, 112a, 108a of the respective die 118, 114, 112, 108. The inclined surfaces 118m, 114m, 112m and 108m are best seen in FIG. 5B. The base surfaces 118m, 114m, 112m 108m are sloped, so that a distance between the face 118a, 114a, 112a, 108a (respectively) and the base surface 118m, 114m, 112m, 108m (respectively) at the plane of symmetry S is less than a distance between the face and base surface adjacent to either of the first vertices 118h, 114h, 112h, 108h or the second vertices 118i, 114i, 112i, 108i.

As most clearly seen in FIG. 5B, the extrusion die 118 is oriented so that the first die channel 118b faces downward, towards the tip of the nozzle 100, with the base 118m sloping downwardly from the inlets 118c to the center of FIG. 5B. The extrusion die 114 is oriented so that the second die channel 114b faces downward, towards the tip of the nozzle 100, with the base 114m sloping downwardly from the inlets 114c (in and out of the page, obscured in FIG. 5B) to the front FIG. 5B. The extrusion die 112 is oriented so that the third die channel 112b faces downward, towards the tip of the nozzle 100, with the base 112m sloping downwardly from the inlets 112c to the center of FIG. 5B. The extrusion die 108 is oriented so that the first die channel 108b faces upward, away from the tip of the nozzle 100, with the base 108m sloping upwardly from the inlets 108c to the center of FIG. 5B. In addition to the depth of the channels 118b, 114b, 112b and 108b being greater near the inlets than at the center, the width of each channel is also smaller at the center than at either of the first and second vertices, as best seen in FIG. 11E.

The flow channels deliver a plurality of layers of thermoplastic material from the extrusion dies so that at least three of the layers combine within the nozzle at substantially the same coordinate 150 measured along the longitudinal axis A. Preferably, the exemplary nozzle 100 uses particular flow channels to create four-layer annular flow from four concentric exit orifices 118n, 114n, 112n, 108n. The point of combination 150 of the layers is nearly simultaneous, as best seen in FIG. 5C. In the example, a flow dam insert 116 keeps the flow layers from extrusion dies 118 and 114 separate from each other until the longitudinal coordinate of combination 150 is reached (i.e., until the first and second layers substantially reach a coordinate 150 along the longitudinal axis A at which the second layer contacts the third layer of thermoplastic material.). This eliminates surfaces that need to be wiped clean when an interior layer is shut off.

Similarly, the separation disk 110 keeps the flow from extrusion dies 112 and 108 separate from each other until the point of combination 150 is reached. Thus, the fourth extrusion die 108 delivers a fourth layer of material substantially at the coordinate along the longitudinal axis at which the second layer of thermoplastic material contacts a third layer of thermoplastic material. In other embodiments (not shown) having more than four layers, additional flow dams and/or separator disks may be used to maintain the layers of thermoplastic material separate from each other until all of the layers reach substantially the same longitudinal coordinate.

Keeping the four layers separate until all four streams reach substantially the same longitudinal coordinate 150 for combination allows the flow from any of the inside orifices to be stopped without creating a surface that has to be wiped clean of residue material by flow from other layers. This is important to allow layers to be stopped and started in a precise fashion.

Although each of the extrusion dies 118, 114, 112 and 108 has a double coat hanger channel 118b, 114b, 112b and 108b, respectively, the configuration of through-passages in each die is unique, as shown in FIGS. 5A and 6-10.

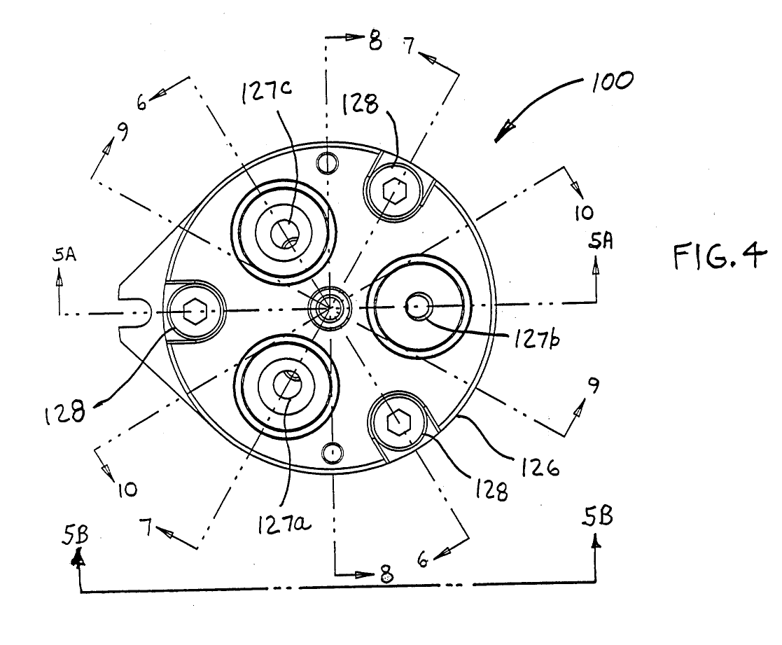

In a nozzle having at least three dies, the second one of the extrusion dies receives at least a second and a third material by way of the first extrusion die, and passes at least the third material on to the third extrusion die. In the preferred example of FIGS. 1-11E, having four extrusion dies, the first one of the extrusion dies has thee pairs of passages therethrough, for permitting three respective materials to pass from the three nozzle inlets through the first extrusion die. The three exemplary pairs of passages are coupled to second, third and fourth extrusion dies, respectively.

Referring now to FIG. 11A, layer 1 (extrusion die 118) accepts the three thermoplastic materials from the six feed channels, and passes four of them directly to layer 2 (extrusion die 114), via passages 118q-118t. As best seen in FIG. 10, two of the feed channels 124a and 124b are split. A portion of the flow is used to feed two modified coat hanger die channels 118b that distribute the flow from the circular feed channels into an annular flow channel 118n that surrounds the valve pin 132 (FIG. 5C). This material forms the inside layer at the exit 106a of the nozzle 100. As best seen in FIG. 10, the inlets 118c are aligned with passages 114u and 114v that go directly through the second die 114, passages 112u and 112v that go directly through the third die 112, and passages 110u and 110v that go directly through separation disk 110, terminating at the inlets 108c of die 108. The remaining flow of the first material that is not distributed to annular flow channel 118n at the first layer 118 passes through layers two and three (dies 114 and 112) to layer four (die 108) where it makes the outside layer of the article. An additional passage 118p through die 118 receives the alignment dowel pin 120.

The second extrusion die 114 receives the first, second and third materials by way of the first extrusion die 118, and passes the first and third material on to the third extrusion die 112. Referring to FIGS. 8 and 11B, layer 2 (extrusion die 114) accepts the six feed channels from layer 1 and uses two of them—inlets 114c are fed by passages 118r and 118t of die 118—to create layer two of the article as above. The material in inlets 114c flows into annular flow channel 114n (FIG. 5C). The remaining four channels 114q, 114s, 114u and 114v pass through layer 2 (die 114) to layer 3 (die 112). An additional passage 114p through die 114 receives the alignment dowel pin 120.

The third extrusion die 112 receives the first and third materials and passes the first material on to the fourth extrusion die 108. Referring to FIGS. 9 and 11C, Layer 3 (extrusion die 112) accepts the four feed channels 114q, 114s, 114u and 114v from layer 2 (die 114) and uses the material flow from two of them (a first passage 118q, 114q and a second passage 114s, 114s, entering through inlets 112c) to create the third annular layer of material as above. The material flows into the annular flow channel 112n (FIG. 5C). The remaining two channels 114u and 114v pass through layer 3 and the separation disk 110 to layer 4 (extrusion die 108). An additional passage 112p through die 112 receives the alignment dowel pin 120.

The fourth extrusion die 108 receives the first material by way of the first, second and third extrusion dies 118, 114 and 112, respectively, and provides a second annular flow of the first material to be output from the nozzle 100. This forms the outermost annular cover layer of the article. Referring to FIGS. 11D and 10, layer 4 (extrusion die 108) accepts two feed channels from the passages in the separation disk 10, which in turn receive flow via a first passage comprising inlets 118c, channel portions 118u and 118v, second layer passages 114u and 114v and third layer passages 112u and 112v from die 112. Extrusion die 108 receives the flow at an inlet portion 108c of the die, and uses the material to create the fourth annular layer, the outside layer of the article. The material in die 108 flows into annular flow channel 108n (FIG. 5C). An additional passage 108p through die 108 receives the alignment dowel pin 120.

The nozzle 100 has a gate 106a. The first, second and third layers or thermoplastic material are combined into a co-extrusion substantially at the same coordinate 150 along the longitudinal axis A, and the co-extrusion is provided at an exit of the nozzle 100.

The respective die channels 118b, 114b of at least the first and second extrusion dies 118 and 114 face the gate 106a of the nozzle 106, and the respective die channel 108b of one of the at least three extrusion dies 118, 114, 108 other than the first and second extrusion dies faces away from the gate 106a of the nozzle. In the example, with four dies, the first three dies 118, 114, 112 face the gate 106a, and the fourth die 108 faces away from the gate. For any given number of three or more layers, it is convenient for the thermoplastic material to enter the channel of the last extrusion die via the front face, instead of via holes through the rear face.

In addition to the above components, an alignment pin 130 aligns the body 102 with the inlet portion 126. A plurality of fasteners 128 fasten the inlet portion 126 to the body 102. An inlet seal 122 prevents leakage between the tubular extension on the top of the first extrusion die 118 and the inlet portion 126. A tip seal 104 between the tip insert 106 and the tip of the nozzle body 102.

Although, in the example shown and described above, the first material is distributed to both the first and fourth layers, one of ordinary skill can route the materials through the layers in a variety of ways, so that any two layers share the same constituent material. For example, in one variation, the first and third layers of the co-extrusion are formed of the same material. In another variation, the second and fourth layers of the co-extrusion are formed of the same material.

The nozzle structure described above may be used to perform functions that were not practical with prior art nozzles. For example, the exemplary nozzle described above has four extrusion dies 118, 114, 112, 108 to feed four respective layers of material to a gate 106a of the nozzle 100; the first and fourth extrusion dies 118, 108 receive a first one of the thermoplastic materials from a common source. In one method according to the invention, the position of the throttle pin 132 is adjustable to vary a ratio between a flow rate of the first thermoplastic material through the first extrusion die 118 and a flow rate of the first thermoplastic material through the fourth extrusion die 108. For this purpose, either a straight throttle pin 132 (e.g., pin 132 in FIG. 10) may be used, or a throttle pin having a diameter that varies along its length (e.g., pin 132′ in FIG. 5A, only a portion of which is shown). By varying the ratio of the innermost and outermost layers, a variety of advantageous products are achievable.

One variation of the method includes the step of controlling flow of the first thermoplastic material so that the innermost one of the annular layers is thinner than an outermost one of the annular layers. Assume, for example, that the first material is PET, forming the innermost and outermost layers of the article, which is a pre-form for a bottle. If the second material is a scavenging barrier layer, forming a thinner innermost (first) layer results in the scavenger layer being located close to the contents of the bottle. This enhances the ability to reduce the amount of dissolved oxygen in the inner skin, to reduce oxidation of the contents of the bottle.

In another variation, the step of flow of the first thermoplastic material can be controlled so that the innermost one of the annular layers is thicker than an outermost one of the annular layers. In this case, if the third layer (from the inside) is a barrier layer, then the barrier layer is next to a relatively thin outermost layer, and the barrier layer has an environment with a lower relative humidity.

Because the nozzle 100 can accommodate three different materials, it provides great flexibility. For example, one of the interior annular layers may be recycled plastic. The recycled plastic can be thoroughly encapsulated between inner and outer layers of virgin plastic. A barrier layer can be incorporated between the inner virgin plastic layer and the recycled plastic layer. The exemplary nozzle allows precise control over the relative thickness of each of the four layers.

The exemplary embodiment of the invention is well adapted for extruding articles in accordance with the teachings of U.S. Pat. No. 6,187,241 B1, wherein a multilayer article is formed from a flow having an annular profile.

The article can be in the configuration of a disk or a tube. The tube could be a preform that is subsequently blown into a bottle or used in the as molded shape. In the case of a tube configuration the material will flow through the gate in the center of the closed end of the tube to the open end forming layers.

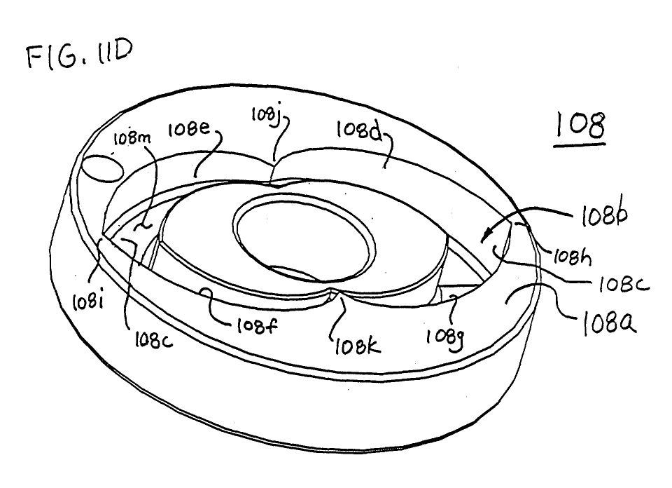

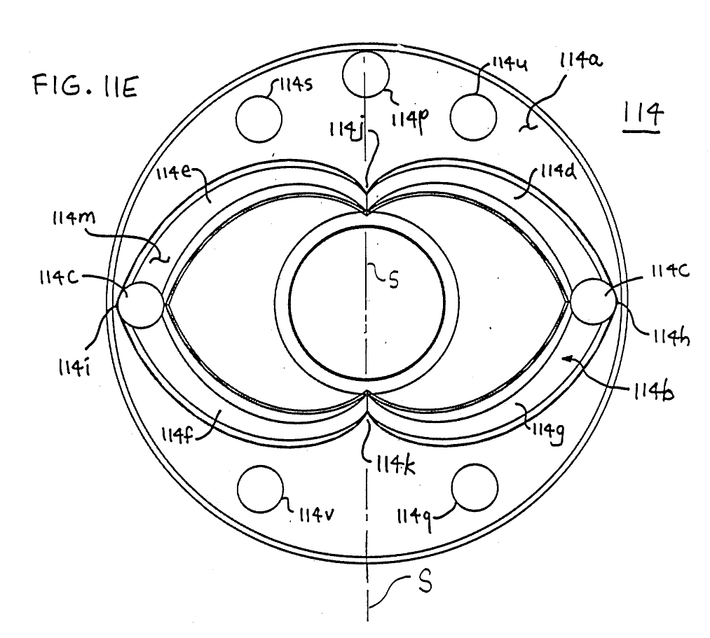

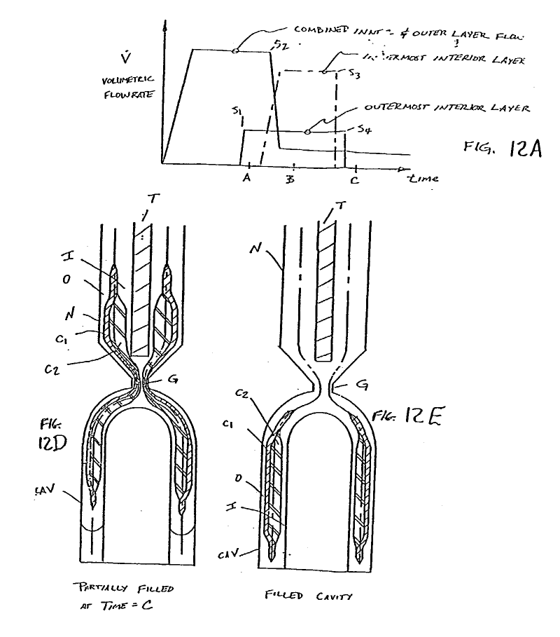

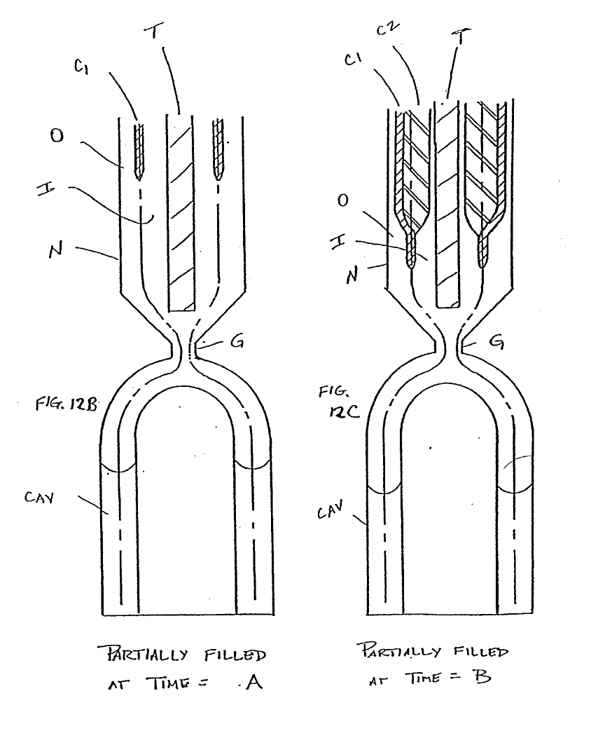

The articles created with this nozzle have four layers of three materials or fewer. The Inner and Outer layers are formed of the same material, usually PET (Polyethylene Terephthalate), but could include many other resins including Polypropylene, Polyethylene and Polyethylene Naphthalate (PEN). The inner and outer layers can fully encapsulate the inner core layer and the outer core layer on the opened end and the closed end of the article. This configuration is shown at different times during its formation in FIGS. 12B to 12E.

FIG. 12A is an exemplary timing diagram for injection of the three materials for the inner and outer layers, and the first and second core layers. Notably, injection of the first core layer material begins while the inner and outer layer material is still being injected, and the second core layer material begins injection while both the inner and outer layer material and the first core layer material are being injected. In this example, injection of the three materials is completed in the opposite order from the beginning of injection. The second core layer completes injection, then the first core layer, and finally, the inner and outer layer materials.

In FIG. 12A, the first-flowing interior layer C1 (in this case the outermost interior layer in the molded object) starts to flow at time S1. The second-flowing interior layer C2 (in this case the innermost interior layer) starts flowing at time S2 which also corresponds with the reduction of the flow rate of the combined inner and outer layer flow.

FIG. 12B shows the flow in the nozzle and partially-filled cavity at time A of FIG. 12A; this time being between the time S1 and S2. The leading edge of the first-flowing interior layer C1 is on the zero velocity gradient point of the combined flow velocity profile, thus assuring its uniform penetration in the molded object.

FIG. 12C shows the partially filled cavity at time B of FIG. 12A. The leading edge of the first-flowing interior layer C1 remains on the zero velocity gradient, while the later-flowing portions of the first-flowing interior layer are moved off the zero velocity gradient by the second-flowing interior layer C2, and are closer to the wall of the extruder.

FIG. 12D shows the position of the flows in the nozzle and cavity at time C of FIG. 12A. The second-flowing interior layer C2 has ceased flowing at time S3, thereby allowing the final flow portion of the first-flowing interior layer C1 to return to the zero gradient just before its flow is terminated, at S4.

FIG. 12E shows the filled cavity when the trailing edge of the first-flowing interior layer C1 has been injected into the cavity by the continued flow of the combined inner and outer layer flow (I and O) after time C, of FIG. 12A. The filled cavity shows the first-flowing interior layer C1 closer to the outer wall in the portions of the filled cavity corresponding to the simultaneous flow of the second-flowing interior layer C2.

In the configuration as shown in FIG. 12E, the leading and trailing edges of the core layer C1 lie along the zero velocity gradient. This ensures that the longitudinal positions of the leading edge and trailing edge are substantially uniform all around the article, even if the material is injected slightly off center. In the remaining portion of the core layer, the second-flowing interior layer C2 overlies the zero velocity gradient. This allows the second-flowing interior layer to constitute a relatively large percentage of the total mass flow. For example, the second flowing core layer C2 may be recycled or off-specification polymer, so that it is cost effective to use a relatively thick layer C2 encapsulated in plastic. Preferably, the centroid of the combined core layers C1 and C2 is on the zero velocity gradient.

The inner core layer and the outer core layer can be used in combination to increase the performance of the container or lower the cost of the container. Table 1 lists five different examples of combinations of inner and outer core layers, and exemplary benefits for each configuration. These are only exemplary, and one of ordinary skill in the art will understand that other configurations are also possible using the exemplary nozzle.

TABLE 1

| | Inner Core | Outer Core | |
|---|---|---|---|
| Configuration | Layer | Layer | Benefits |
| 1 | Recycled | Barrier | Reduced raw material |
| | Polymer | | costs with optimized |
| | | | barrier position |
| 2 | Recycled | Oxygen- | Reduced raw material cost |
| | Polymer | Scavenging | with optimized barrier |
| | | Barrier | position for oxygen |
| | | | sensitive contents. |
| 3 | Oxygen | Barrier | Optimized oxygen |
| | Scavenger | | scavenger and barrier |
| | | | positions that work in |
| | | | combination. |
| 4 | Oxygen | Recycled | Reduced raw material cost |
| | Scavenger | Polymer | with optimized oxygen |
| | | | scavenger position. |
| 5 | Oxygen- | Recycled | Reduced raw material cost |
| | Scavenging | Polymer | with optimized oxygen |
| | Barrier | | scavenger position for |
| | | | Products that require |
| | | | barrier. |

In one configuration where improved barrier performance is required a high barrier polymer such as MXD6 or Ethylene Vinyl Alcohol Polymer (EVOH) can be used in the outer core layer C1, and Recycled or off-specification polymer can be used in the inner core layer C2. Most barrier materials perform better in lower relative humidity, so using the barrier in the outer core layer C1 can improve the performance of the barrier and the value of the container. The outer core layer C1 can also be an oxygen-scavenging barrier for oxygen sensitive contents. Because both core layers can be encapsulated, the recycled skin material in layer C2 does not contact the contents of the article and does not require the pedigree associated with material used in direct food contact.

In another configuration an oxygen scavenger is used in the inner core layer C2 and a barrier is used in the outer core layer C1. When an oxygen scavenger is used in this configuration the performance of the container is improved in many ways. When an oxygen scavenger is positioned more closely to the contents of the container, it can scavenge oxygen that is trapped in the container during the filling process as well as the oxygen in the inner layer of the bottle. The inner skin layer of the bottle is also thinner so it contains less oxygen upon filling the bottle. The outer core layer C1 of barrier and the outer layer O protect the scavenging layer from oxygen in the atmosphere. This extends the life of the oxygen scavenger and consequently the performance of the bottle.

In another configuration an oxygen scavenger or oxygen-scavenging barrier material can be used on the inside layer C2, and recycled or off-specification material may be used in the outside core C1. In this configuration the performance of the container is improved as described above except the oxygen scavenger is protected by the outer core layer C1 of recycled polymer and the outer layer O instead of a barrier layer and outer layer.

In other configurations, either of the inner or outer core layers may be a humidity control barrier layer or an electromagnetic shielding layer.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A die for extruding thermoplastic material, of a type having at least one inlet for receiving the thermoplastic material and at least one outlet for distributing the thermoplastic material,
said die having a face, with a channel in said face, said channel providing the outlet for distributing the thermoplastic material,
said channel being a closed geometric figure,
said channel having at least two arcuate portions, said arcuate portions meeting to form at least first and second vertices of said closed geometric figure,
said first and second vertices having first and second inlets for receiving the thermoplastic material.

2. The die of claim 1, wherein the channel has a kiss shape.

3. The die of claim 1, wherein the channel has at least a first arcuate portion, a second arcuate portion, a third arcuate portion and a fourth arcuate portion.

4. The die of claim 3, wherein:
the first and fourth arcuate portions meet at the first vertex,
the second and third arcuate portions meet at the second vertex, and
the first and second vertices point outwardly, away from a center of the die.

5. The die of claim 4, wherein:
the first and second arcuate portions meet at the third vertex,
the third and fourth arcuate portions meet at the fourth vertex, and
the third and fourth vertices point inwardly, towards a center of the die.

6. The die of claim 1, wherein:
the channel has a base surface that is inclined relative to the face of the die.

7. The die of claim 6, wherein:
the channel has a plane of symmetry substantially midway between the first and second vertices, and
the base surface is sloped, so that a distance between the face and the base surface at the plane of symmetry is less than a distance between the face and base surface adjacent to either of the first or second vertices.

8. The die of claim 7, wherein the base surface has a width that is smaller at the plane of symmetry than at either of the first and second vertices.

9. A nozzle for extruding an article having at least three layers of thermoplastic materials, comprising:
a housing having a longitudinal axis;
at least three extrusion dies contained in the housing and aligned with the longitudinal axis, each die having a face with a die channel in said face, each die channel being a closed geometric figure, each die channel having at least one inlet for receiving a respective thermoplastic material, each die channel providing a respective outlet for feeding a respective one of the plurality of layers of thermoplastic materials to a respective flow channel within the housing;
said flow channels delivering the plurality of layers so that at least three of the layers combine within the nozzle at substantially the same coordinate measured along the longitudinal axis.

10. The nozzle of claim 9, wherein the nozzle has four extrusion dies.

11. The nozzle of claim 9, wherein the nozzle outputs four annular flow layers of the thermoplastic materials.

12. The nozzle of claim 9, further comprising three nozzle inlets for receiving three thermoplastic materials, the three nozzle inlets being coupled to respective ones of the extrusion dies.

13. The nozzle of claim 12, further comprising a distribution layer that separates the flow of material from each respective nozzle inlet into a pair of feed channels, each pair of feed channels providing thermoplastic material to a respective extrusion die.

14. The nozzle of claim 13, wherein each extrusion die has a pair of die inlets for receiving a respective thermoplastic material from each one of the pair of feed channels corresponding to that extrusion die.

15. The nozzle of claim 12, wherein a first one of the extrusion dies has at least two pairs of passages therethrough, for permitting materials to pass from two of the nozzle inlets through the first extrusion die, the two pairs of passages being coupled to a second one of the extrusion dies and a third one of the extrusion dies, respectively.

16. The nozzle of claim 15, wherein the second one of the extrusion dies receives at least a second and a third material by way of the first extrusion die, and passes at least the third material on to the third extrusion die.

17. The nozzle of claim 12, wherein a first one of the extrusion dies has thee pairs of passages therethrough, for permitting three respective materials to pass from the three nozzle inlets through the first extrusion die, the three pairs of passages being coupled to a second one of the extrusion dies, a third one of the extrusion dies, and a fourth one of the extrusion dies, respectively.

18. The nozzle of claim 17, wherein the second extrusion die receives the first, second and third materials by way of the first extrusion die, and passes the first and third material on to the third extrusion die.

19. The nozzle of claim 18, wherein the third extrusion die receives the first and third materials and passes the first material on to the fourth extrusion die.

20. The nozzle of claim 9, wherein:
the nozzle has four extrusion dies
the first extrusion die provides a first annular flow of a first one of the materials to be output from the nozzle, and
the fourth extrusion die receives the first material by way of the first, second and third extrusion dies, and provides a second annular flow of the first material to be output from the nozzle.

21. The nozzle of claim 9, wherein the die channels in the first, second and third extrusion dies have substantially the same shape.

22. The nozzle of claim 21, wherein the die channels in the first, second and third extrusion dies have a kiss shape.

23. The nozzle of claim 21, wherein the die channels in the first, second and third extrusion dies have a non-circular shape, and the die channels in the first, second and third extrusion dies are axially offset from each other.

24. The nozzle of claim 21, wherein a pair of passages are formed that penetrate the first, second and third extrusion dies, the pair of passages passing through the vertices of the first extrusion die and ending at the vertices of the fourth extrusion die.

25. The nozzle of claim 9, further comprising a flow dam that prevents a first one of the plurality of layers of thermoplastic material from contacting a second one of the plurality of layers of thermoplastic material until the first and second layers substantially reach a coordinate along the longitudinal axis at which the second layer contacts a third one of the plurality of layers of thermoplastic material.

26. The nozzle of claim 25, wherein the nozzle has four extrusion dies, which provide four outlets for feeding respective ones of the plurality of layers of thermoplastic materials, and the fourth extrusion die delivers a fourth layer of material substantially at the coordinate along the longitudinal axis at which the second layer contacts a third one of the plurality of layers of thermoplastic material.

27. The nozzle of claim 9, wherein:
the nozzle has a gate,
the respective die channels of at least the first and second extrusion dies face the gate of the nozzle, and
the respective die channel of one of the at least three extrusion dies other than the first and second extrusion dies faces away from the gate of the nozzle.

28. The nozzle of claim 9, further comprising a throttle pin extending along the longitudinal axis.

29. The nozzle of claim 28, wherein:
the nozzle has four extrusion dies to feed four respective layers of material to a gate of the nozzle;
the first and fourth extrusion dies receive a first one of the thermoplastic materials from a common source; and
the throttle pin is adjustable to vary a ratio between a flow rate of the first thermoplastic material through the first extrusion die and a flow rate of the first thermoplastic material through the fourth extrusion die.

30. A method for extruding thermoplastic material, comprising the steps of:
(a) distributing first, second and third thermoplastic materials to at least three extrusion dies at respective first, second and third coordinates along a longitudinal axis within a single nozzle;
(b) forming first, second and third layers of the first, second and third thermoplastic materials, respectively, in respective ones of the at least three extrusion dies; and
(c) combining the first, second and third layers into a co-extrusion substantially at a fourth coordinate along the longitudinal axis; and
(d) providing the co-extrusion at an exit of the nozzle.

31. The method of claim 30, wherein step (a) includes distributing the thermoplastic material to four extrusion dies within a single nozzle at respective first, second, third and fourth coordinates along a longitudinal axis.

32. The method of claim 31, wherein:
step (a) includes distributing the first thermoplastic material to the first extrusion die and the fourth extrusion die, and
step (b) includes forming a first annular layer and a fourth annular layer from the first thermoplastic material.

33. The method of claim 32, wherein step (a) includes distributing the first thermoplastic material to the fourth extrusion die via passages through the first, second and third extrusion dies.

34. The method of claim 32, further comprising the step of controlling flow of the first thermoplastic material so that the innermost one of the annular layers is thinner than an outermost one of the annular layers.

35. The method of claim 34, wherein step (b) includes forming a scavenging barrier layer adjacent to the innermost one of the annular layers.

36. The method of claim 32, further comprising the step of controlling flow of the first thermoplastic material so that the innermost one of the annular layers is thicker than an outermost one of the annular layers.

37. The method of claim 36, wherein step (b) includes forming a barrier layer adjacent to the outermost one of the annular layers.

38. The method of claim 32, further comprising varying a ratio between the thicknesses of the first and fourth annular layers by moving a throttle pin within the nozzle.

39. The method of claim 30, wherein the first and third layers of the co-extrusion are formed of the same material.

40. The method of claim 30, wherein the second and fourth layers of the co-extrusion are formed of the same material.

41. The method of claim 30, wherein step (a) includes distributing the second thermoplastic material to the second extrusion die via at least one passage in the first extrusion die.

42. The method of claim 30, wherein step (a) includes distributing the third thermoplastic material to the third extrusion die via at least one passage in the first extrusion die and at least one passage in the second extrusion die.

43. The method of claim 30, further comprising receiving the first, second and third thermoplastic materials via three nozzle inlets.

44. The method of claim 30, wherein
at least one of the layers is annular, and
step (b) includes distributing the respective one of the thermoplastic materials to the annular layer so that there is a substantially equal pressure drop for any streamline between a nozzle inlet corresponding to the respective thermoplastic material and any location on the annular layer of that one thermoplastic material at a given coordinate along the longitudinal axis.

45. The method of claim 30, wherein step (b) includes distributing at least one of the thermoplastic materials via at least two die inlets in a respective one of the extrusion dies.

46. A hollow molded plastic material article, comprising:
inner and outer plastic wall layers; and
first and second interior plastic core layers encased within the inner and outer plastic wall layers, said first and second core layers being formed adjacent to each other from two different materials,
one of said first and second core layers being adjacent to the inner plastic wall layer,
the other of said first and second core layers being adjacent to the outer plastic wall layer.

47. The article of claim 46, wherein the first and second core layers include two of the group consisting of a recycled plastic layer, a humidity control barrier layer, a gas permeation barrier layer, a gas scavenging layer and an electromagnetic shielding layer.

48. The article of claim 46, wherein the article has not more than four layers.
